(19) United States
(12) Patent Application Publication
(10) Pub. No.: US 2026/0057382 A1
(43) Pub. Date: Feb. 26, 2026

(54) SYSTEMS AND METHODS FOR A PERMISSIONLESS DECENTRALIZED VIRTUAL ASSET NETWORK

(71) Applicant: Pylons, Inc., New York, NY (US)

(72) Inventor: Michael Sofaer, New York, NY (US)

(73) Assignee: Pylons, Inc., New York, NY (US)

(21) Appl. No.: 19/375,574

(22) Filed: Oct. 31, 2025

Related U.S. Application Data
(63) Continuation of application No. 19/287,313, filed on Jul. 31, 2025.
Application No. 19/287,313 is a continuation of application No. 17/479,964, filed on Sep. 20, 2021, now abandoned.
(60) Provisional application No. 63/080,667, filed on Sep. 18, 2020.

(51) Int. Cl. G06Q 20/40; G06Q 20/04

(52) U.S. Cl. CPC G06Q 20/4014; G06Q 20/047; G06Q 2220/00

(57) ABSTRACT

A blockchain system for containing authority within a distributed consensual system includes a blockchain network of participating user devices. A participating user device, having a memory and a processor, is configured to create an account linking blockchain transaction to link a developer account with an external authority account of a user of the device. The user device is further configured to publish a recipe associated with the user's developer account, receive, from an external authority, a receipt indicating purchase of the recipe by another user connected to the distributed consensual system, create a recipe blockchain transaction including data identifying the recipe and the receipt, and broadcast the recipe blockchain transaction on the blockchain network. Upon validation, the user receives payment via one or more additional blockchain transactions.

### PRIORITY

This application is a Continuation of U.S. Ser. No. 19/287,313, which claims the benefit to U.S. Non-Provisional application Ser. No. 17/479,964, filed Sep. 20, 2021, and U.S. 63/080,667, filed Sep. 18, 2020, each of which is hereby incorporated by reference as if submitted in its entirety.

### FIELD OF THE INVENTION

The present invention relates to a permissionless blockchain network and system, and, more particularly, a permissionless blockchain network and system for creating and trading virtual assets using an external authoritarian system.

### BACKGROUND

People love virtual assets, and value them highly (over a billion USD is spent annually on Fortnite skins alone). Owners of virtual assets are frustrated by an inability to freely control what they feel they have earned, in particular to buy and sell them freely, which most platforms forbid. Many third-party services already exist to facilitate illicit transfers of virtual assets. People currently spend large amounts of money (hundreds of dollars in a transaction is common) on those transfers. These services, however, are unreliable, expensive, because they are illicit, and thus fundamentally unsatisfying.

This dissatisfaction is driven fundamentally by the total power the database operator has over all items, and the complete lack of recourse a user has against the database operator. Further, the centrality of walled gardens to the virtual asset experience creates a very high barrier to entry to smaller and more innovative virtual experience designers who cannot simply focus on the user, but must focus on how to get access to a platform the user already uses, or try to entice the user to use a new proprietary platform.

Virtual assets have existed for decades, always controlled by corporations and their data systems, and for as long as they have existed people have been passionate about them, and passionate about avoiding the rules imposed by the companies that run them. Free buying and selling of virtual assets are almost never allowed on a platform, and because people want free buying and selling, they figure out awkward and expensive ways to make it happen.

Examples of the creative power spent getting around the pain of those closed systems are everywhere such systems exist. In the early days there were external markets for trading internal items-Steve Bannon and Brock Pierce got their starts running a World of Warcraft gold market. An August 2020 thread on Twitter describes a scheme among many children to work around Neopets' rules in around 2000.

As companies realized that anything that could be freely traded or given in-game would have deals negotiated out of band to avoid limitations and involve real money, they adapted by locking items to accounts and switching to loot box mechanics. Once accounts were locked down in this way, third party businesses emerged to mediate selling entire accounts to move the items on them.

Prior art systems exist within closed systems, or networks, wherein an entity, typically a corporate entity, retains control and flexibility at the expense of the users' ability to create and trade virtual assets. It would be beneficial to have a platform to provide virtual asset system that mitigated many of the technical problems of conventional virtual asset systems.

What the virtual asset market needs is a system that will succeed at scale by being inexpensive to operate and that takes low fees, so that the vast bulk of profits will go to the creative people building experiences on the platform. Getting out of the way of developers and making their work easy and the network costs affordable with the invention of this disclosure, will encourage a community of creators that will change the face of self-expression on the internet.

As consensual systems, built on distributed consensus technology, grow, and become more integrated into the broader economy they must inevitably interact at their edges with systems that behave arbitrarily and have no fidelity guarantees.

Tools of dealing with byzantine behavior are not useful in these situations because these systems, no matter how arbitrary, represent ground truth and their input cannot be rejected by the consensus, it must be ingested and dealt with.

The first interfaces between distributed ledgers and the broader world were exchanges, such as Mt. Gox® and Tradehill® had bitcoin and bank accounts, and managed user balances on their own balance sheets. These exchanges acted, and their successors still act, as full agents of the users both on-chain and with respect to the off-chain assets that are at issue.

Use of these systems creates total counterparty risk for any particular transaction, and can often by slow, and subject to capricious behavior by the exchange.

The cryptocurrency community has started to build systems that minimize counterparty risk when interfacing between two consensual systems. These tools often involve bridges that carry some risk, but this risk is more susceptible to analysis, and is much less capricious.

Prior art systems that need to interface with the outer world typically use blockchain oracles (e.g., Band® and Chainlink®). These systems involve a consensus system to agree on the state of the outer world, they do not privilege an external authority to authorize transactions within a consensual system.

In another example, Ripple Labs® created a payment protocol and exchange network where users could issue arbitrary debt in any denomination, and other users could decide how much exposure to that risk they were willing to take. They then built an orderbook that allowed orders to pass through the system by using the liquidity created by those exposure settings. Unfortunately, the management overhead of creating and managing all the debt is too high.

### BRIEF SUMMARY OF THE INVENTION

The present embodiments may relate to, inter alia, systems and methods for providing a permissionless blockchain for the creation and trading of virtual assets using a blockchain-based digital asset platform. In some embodiments, the blockchain-based digital asset platform may provide an underlying framework for the creation and transfer of virtual assets that is performant, easy for developers to build on, and simple for users to engage with. Additionally, or alternatively, the blockchain-based digital asset platform may be an open-source blockchain ecosystem that provides interoperability between users among disparate networks. In some embodiments, the ecosystem allows for the collection and display of users' digital identities without involving proprietary systems.

In another aspect, the present embodiments may relate to systems and methods for providing a decentralized exchange including a user-driven interface with an external authoritarian system. In some embodiments, a user may link one or more of their consensual accounts to one or more of their authoritarian accounts. Additionally, or alternatively, a user may initiate a transaction that associates one of their consensual accounts with one of their authoritarian accounts. The transaction, for example, may cause the association to be labeled with an account identifier, which may be displayed on the user's profile.

In yet another aspect, the present embodiments may relate to systems and methods for containing authority within a distributed consensual system, the distributed consensual system including a blockchain network. A computing device of the system may be caused to: create an account linking blockchain transaction to link a developer account with an external authority account, broadcast the account linking blockchain transaction on the blockchain network, publish a recipe associated with the developer account, receive, from an external authority, a receipt indicating purchase of the recipe by a computing device connected to the distributed consensual system, create a recipe blockchain transaction including data identifying the recipe and the receipt, broadcast the recipe blockchain transaction on the blockchain network, and receive payment from the computing device via the blockchain network in response to validation of the recipe blockchain transaction by the blockchain network.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

This disclosure is illustrated by way of example and not by way of limitation in the accompanying figure(s). The figure(s) may, alone or in combination, illustrate one or more embodiments of the disclosure. Elements illustrated in the figure(s) are not necessarily drawn to scale. Reference labels may be repeated among the figures to indicate corresponding or analogous elements.

The detailed description refers to the accompanying figures in which:

FIG. 1 illustrates a simplified block diagram of a Permissionless Decentralized Virtual Asset (PDVA) computing system in accordance with at least one embodiment of the present disclosure;

FIG. 2 illustrates an exemplary configuration of a client computing device as shown in FIG. 1, in accordance with at least one embodiment of the present disclosure;

FIG. 3 illustrates an exemplary configuration of a server computing device as shown in FIG. 1, in accordance with at least one embodiment of the present disclosure; and

FIG. 4 illustrates an exemplary networked environment of a Permissionless Decentralized Virtual Asset (PDVA) blockchain system in accordance with at least one embodiment of the present disclosure.

FIG. 5 illustrates an exemplary data flow diagram 500 of a user interacting with a PDVA blockchain system that may be used with the PDVA computing system of FIG. 1.

FIG. 6 illustrates an exemplary data flow diagram 600 of a developer interacting with a PDVA blockchain system that may be used with the PDVA computing system of FIG. 1.

FIG. 7 illustrates an exemplary data flow diagram 700 of a user-driven interface with an external authoritarian system that may be used with the PDVA computing system of FIG. 1.

### DETAILED DESCRIPTION

The figures and descriptions provided herein may have been simplified to illustrate aspects that are relevant for a clear understanding of the herein described apparatuses, systems, and methods, while eliminating, for the purpose of clarity, other aspects that may be found in typical similar devices, systems, and methods. Those of ordinary skill may thus recognize that other elements and/or operations may be desirable and/or necessary to implement the devices, systems, and methods described herein. But because such elements and operations are known in the art, and because they do not facilitate a better understanding of the present disclosure, for the sake of brevity a discussion of such elements and operations may not be provided herein. However, the present disclosure is deemed to nevertheless include all such elements, variations, and modifications to the described aspects that would be known to those of ordinary skill in the art.

The present embodiments may relate to, inter alia, systems and methods for providing a permissionless blockchain for the creation and trading of virtual assets using a blockchain-based digital asset platform. In some embodiments, the blockchain-based digital asset platform may provide an underlying framework for the creation and transfer of virtual assets that is performant, easy for developers to build on, and simple for users to engage with. Additionally, or alternatively, the blockchain-based digital asset platform may be an open-source blockchain ecosystem that provides interoperability between users among disparate networks. In some embodiments, the ecosystem allows for the collection and display of users' digital identities without involving proprietary systems.

Further, the present embodiments may relate to systems and methods for providing a decentralized exchange including a user-driven interface with an external authoritarian system. In some embodiments, a user may link one or more of their consensual accounts to one or more of their authoritarian accounts. Additionally, or alternatively, a user may initiate a transaction that associates one of their consensual accounts with one of their authoritarian accounts. The transaction, for example, may cause the association to be labeled with an account identifier, which may be displayed on the user's profile.

A blockchain is an immutable ledger that contains a set of linked blocks, which have been validated by participants (e.g., miners) in a peer-to-peer (P2P) network. In some embodiments, a blockchain does not require a central authority to manage transactions. Instead, the set of linked blocks of the blockchain is maintained and validated in the decentralized P2P network. In other words, the blockchain is a decentralized distributed and tamper-proof ledger that is shared among every P2P network participant.

Blockchain technology provides many features including, but not limited to, decentralization, traceability, and being tamper-proof The decentralized nature of blockchain enables all the members of the blockchain network to participate in the process of validating transactions, unlike centralization, which allows only the administrator of the network to perform the authorization and validation processes. Further, a blockchain is traceable, making it easy to audit, because all actors in the blockchain have copies of the transactions in the ledger. So, the actors in the blockchain network can validate data exchange (transaction) for a particular blockchain address. Each record stored in a blockchain is assigned a timestamp, subsequently guaranteeing transaction traceability. In addition to ensuring the privacy of users, the blockchain offers a kind of pseudo-anonymity.

A blockchain is also tamper-proof New joining blocks in the blockchain are authorized and validated by all peers in the P2P network through decentralized consensus mechanisms. Therefore, the blockchain is immutable. For example, if an attacker tries to change any record in the blockchain, this would require accommodating the majority of the participants in the network and otherwise would be detected easily.

A blockchain is transparent. Typically, all the users in the blockchain have the same access rights, so they would participate in the process of validating and recording new transactions in the blockchain. Therefore, the recorded data in the ledger would be transparent to all users with access to the blockchain network.

Blockchains may be classified based on their architectural characteristics and their quality attributes. For example, a blockchain may be considered partially decentralized (e.g., permissioned blockchain) or fully decentralized (e.g., permissionless blockchain). Further, a blockchain may be categorized into a private blockchain, public blockchain, or hybrid blockchain, for example. Blockchains may be classified, or categorized, based on different principles, such as authentication or access control mechanisms. Further, different blockchains may be compared based on type, the consensus mechanism, smart contracts, transaction capacity, forks, lack of permission, lack of fees, or the like.

A permissionless blockchain, or public blockchain, typically has no restriction on users joining the blockchain network. Each user, or peer, may have full access rights to participate in validating transactions, take part in the mining process, and maintain blockchain ledgers. An example of a public blockchain is the Bitcoin protocol and payment network designed to support the cryptocurrency bitcoin. The Bitcoin network is designed to support a huge network of anonymous peers, or users. In the Bitcoin network, all peers may participate in the process in validating transactions and managing the network.

The total market for permissionless sale of virtual assets is hard to measure because the industry is secretive, since it inevitably violates the terms of service imposed by the organizations that issue and can arbitrarily revoke those assets. The market for virtual asset issuance is much easier to measure, Fortnite made $1.8 billion in revenue in 2019, almost entirely on virtual assets. And since players cannot resell Fortnite items, dissatisfied players typically sell entire accounts. Magic cards, though not virtual, are tradeable game items with a relatively liquid market, and there is an estimate that they are worth around $2.5 billion in total.

Typically, corporate systems will avoid creating an open network that requires creators on the system to allow the trading of items, as they will want to retain control and flexibility at the expense of their users' ability to trade. So, investor and developer attention has turned to blockchain non-fungible tokens (NFTs). These systems, however, have had almost no success beyond the cryptocurrency enthusiast community. Many virtual assets remain part of closed worlds like Fortnite, Steam, League of Legends, etc. Virtual assets as experienced by users currently exist in a set of isolated walled gardens, the CompuServes and AOLs of digital self-expression. Existing NFT products envision their NFT systems as complete within themselves, with attention and artificial scarcity creating value. But virtual assets are about self-expression, and the ability to display them to others is one of their most powerful features. An NFT system that does not rapidly and smoothly integrate with how regular people interact with each other on the internet will not satisfy the public need for reliable self-expression.

Providing a common platform for virtual assets with basic rules that meet users' needs gives users the level of control they feel is appropriate will attract users who want to escape the frustration of the existing model, and designers who want to make experiences for everyone without building or buying into a walled garden. The virtual asset market is large, growing, and fundamentally better served by an open network than by closed networks. An open network that wins this market will handle tens of billions of dollars in transactions a year, and reasonably gross hundreds of millions for itself

At least one of the technical advantages provided by the disclosed system may include: (1) a powerful custom state machine designed for Non-Fungible Tokens (NFTs) provided as a Layer 1 between a dumb chain and smart contracts that does not require gas fees; (2) a mobile primary platform; (3) the prioritization of external tokens for payment using IBC bridging and custom-authority-containment strategy for fiat payments; (4) a platform that allows users to set exposure limits per payment processor; (5) a platform that allows users to submit receipts to payment processors thereby removing the need to use a traditional oracle; and (6) core property aspects are built into the blockchain (e.g., limits on minting number, royalties, etc.).

### Exemplary Permissionless Decentralized Virtual Asset (PDVA) Computing System

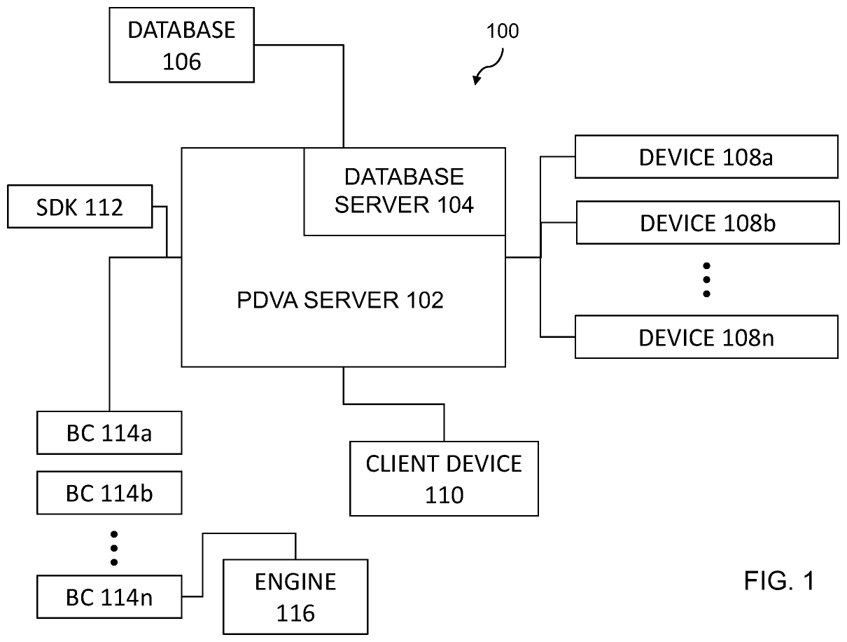

FIG. 1 illustrates a simplified block diagram of an exemplary Permissionless Decentralized Virtual Asset (PDVA) system 100 for the creation and management of virtual assets. As described below in more detail, PDVA server 102 (also known as a PDVA computer device 102), may be configured to provide a permissionless blockchain architecture as described herein.

In the exemplary embodiment, PDVA server may be in communication with one or more user computing devices 108a-108n. User computing devices 108a-108n may be computers that include a web browser or a software application, which enables access remote computer devices, such as PDVA server 102, using the Internet or other network. More specifically, user computing devices 108a-108n may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. User computing devices 108a-108n may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices. In the exemplary embodiment, user computing devices 108a-108n may be associated with different entities that may interact with one another on the network, such as developers (e.g., mobile application or software), network users or administrators, system users or administrators, or the like.

A database server 104 may be communicatively coupled to a database 106. In one embodiment, database 106 may include a copy of a distributed ledger or a blockchain. Additionally, or alternatively, database 106 may include a backend database, such as an open source key-value store (e.g., LevelDB). In some embodiments, database 106 may be located remotely from PDVA server 102. In some embodiments, database 106 may be a decentralized database or a distributed database. In the exemplary embodiment, a user may access database 106 via a user computing device, such as one of computing devices 108a-108n, via server 102, as described herein.

In the exemplary embodiment, PDVA server 102 may be in communication with a plurality of computing devices, such as user computing devices 108a-108n. More specifically, PDVA server 102 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. PDVA server 102 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices. In some embodiments, PDVA server 102 may also be associated with a plurality of user computer device (not shown) that allow individual users to access PDVA server 102 and database 106. In some embodiments, PDVA server 102 may comprise of a plurality of computer devices working in concert.

A data provider SDK 112 may be accessed by PDVA server 102 to load a software development kit (SDK). An SDK may be used as the underlying technological platform of system 100. The SDK may include a set of tools for building self-contained, fast blockchains, such as BC 114a-114n. Additionally, the self-contained blockchains 114a-114n may operate on top of a proven and fast consensus engine 116. The consensus engine 116 may be designed to operate in an operating system, such as a mobile operating system (e.g., Android Go®), on top of a backend database (e.g., LevelDB®). The configuration of the exemplary embodiment may include fast technologies and support very fast transaction resolution.

### Exemplary Client Computing Device

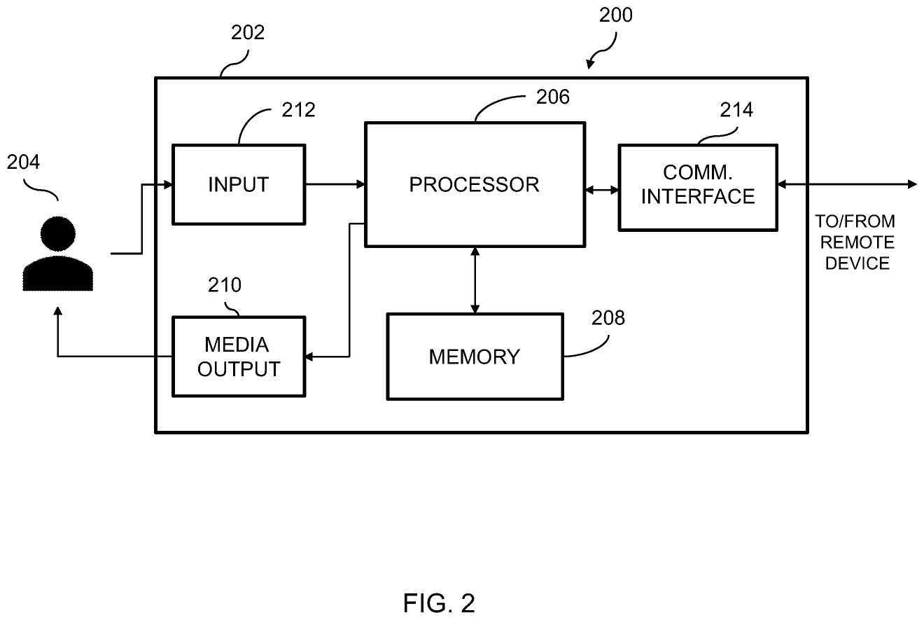

FIG. 2 illustrates a block diagram 200 of an exemplary client computing device 202 that may be used with the Permissionless Decentralized Virtual Asset (PDVA) server computing device 102 shown in FIG. 1. Client computing device 202 may be, for example, at least one of user computing devices 108a-108n (shown in FIG. 1).

Client computing device 202 may be accessible to, and associated with, a user 204. Device 202 may include a processor 206 for executing instructions. In some embodiments, executable instructions may be stored in a memory area 208. Processor 206 may include one or more processing units (e.g., in a multi-core configuration). Memory area 208 may be any device allowing information such as executable instructions and/or other data to be stored and retrieved. Memory area 208 may include one or more computer readable media.

In one or more exemplary embodiments, client computing device 202 may also include at least one media output component 210 for presenting information to a user 204. Media output component 210 may be any component capable of conveying information to user 204. In some embodiments, media output component 210 may include an output adapter such as a video adapter and/or an audio adapter. An output adapter may be operatively coupled to processor 206 and operatively coupled to an output device such as a display device (e.g., a liquid crystal display (LCD), a light emitting diode (LED) display, an organic light emitting diode (OLED) display, a cathode ray tube (CRT) display, an “electronic ink” display, a projected display, etc.) or an audio output device (e.g., a speaker arrangement or headphones).

Client computing device 202 may also include an input device 212 for receiving input from a user 204. Input device 212 may include, for example, a keyboard, a pointing device, a mouse, a stylus, a touch sensitive panel (e.g., a touch pad or a touch screen), a gyroscope one or more sensors or an audio input device. A single component, such as a touch screen, may function as both an output device of media output component 210 and an input device of input device 212.

Client computing device 202 may also include a communication interface 214, which can be communicatively coupled to a remote device, such as PDVA computing device 102, shown in FIG. 1. Communication interface 214 may include, for example, a wired or wireless network adapter or a wireless data transceiver for use with a mobile phone network (e.g., Global System for Mobile communications (GSM), 3G, 4G, 5G, NFC, or Bluetooth) or other mobile data networks (e.g., Worldwide Interoperability for Microwave Access (WIMAX)). The systems and methods disclosed herein are not limited to any certain type of short-range or long-range networks.

Stored in memory area 208 may be, for example, computer readable instructions for providing a user interface to user 204 via media output component 210 and, optionally, receiving and processing input from input device 212. A user interface may include, among other possibilities, a web browser or a client application, such as a mobile application. Web browsers may enable users, such as user 204, to display and interact with media and other information typically embedded on a web page or a website.

Memory area 208 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAN). The above memory types are exemplary only, and are thus not limiting as to the types of memory usable for storage of a computer program.

### Exemplary Server Computing Device

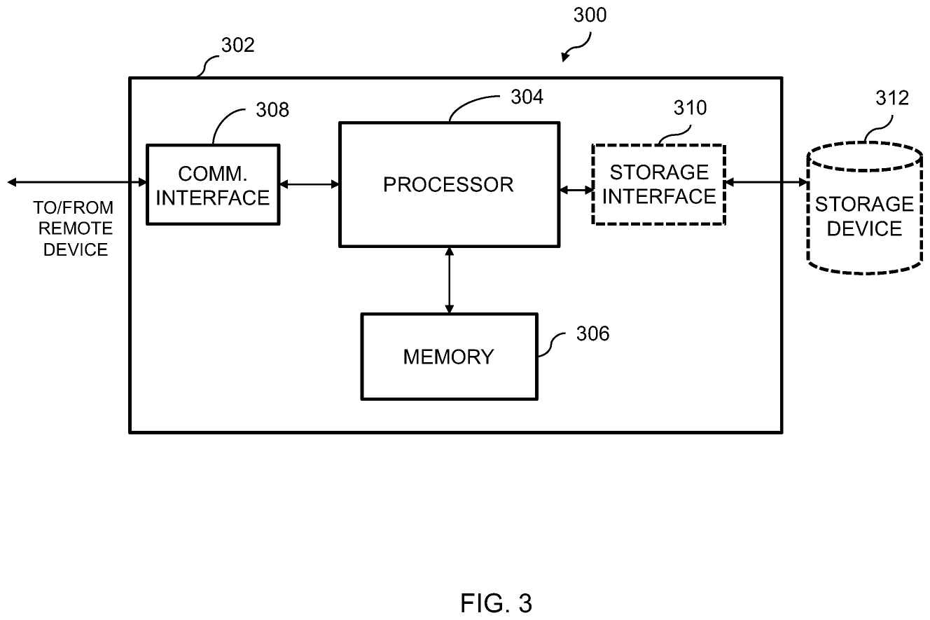

FIG. 3 depicts a block diagram 300 showing an exemplary server system 302. Server system 302 may be, for example, Permissionless Decentralized Virtual Asset (PDVA) computing device 102 or database server 104 (shown in FIG. 1).

In exemplary embodiments, server system 302 may include a processor 304 for executing instructions. Instructions may be stored in a memory area 306.

Processor 304 may include one or more processing units (e.g., in a multi-core configuration) for executing instructions. The instructions may be executed within a variety of different operating systems on server system 302, such as UNIX, LINUX, Microsoft Windows®, etc.

It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, Python, or other suitable programming languages, etc.).

Processor 304 may be operatively coupled to a communication interface 308 such that server system 302 may communicate with PDVA computing device 102 or client device 110 (all shown in FIG. 1), and/or another server system. For example, communication interface 308 may receive data from client device 110 via the Internet or a mobile network.

Processor 304 may also be operatively coupled to a storage device 312, such as database 106 (shown in FIG. 1), via a storage interface 310. Storage device 312 may be any computer-operated hardware suitable for storing and/or retrieving data. In some embodiments, storage device 312 may be integrated in server system 302. For example, server system 302 may include one or more hard disk drives as storage device 312.

In other embodiments, storage device 312 may be external to server system 302 and may be accessed by a plurality of server systems. For example, storage device 312 may include multiple storage units such as hard disks or solid-state disks in a redundant array of inexpensive disks (RAID) configuration. Storage device 312 may include a storage area network (SAN) and/or a network attached storage (NAS) system.

In some embodiments, processor 304 may be operatively coupled to storage device 312 via a storage interface 310. Storage interface 310 may be any component capable of providing processor 304 with access to storage device 312. Storage interface 310 may include, but is not limited to, an Advanced Technology Attachment (ATA) adapter, a Serial ATA (SATA) adapter, a Small Computer System Interface (SCSI) adapter, a RAID controller, a SAN adapter, a network adapter, and/or any component providing processor 304 with access to storage device 312.

Memory area 306 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types not to be considered limiting as to the types of memory usable for storage of the exemplary computing system.

### Permissionless Decentralized Virtual Asset Platform

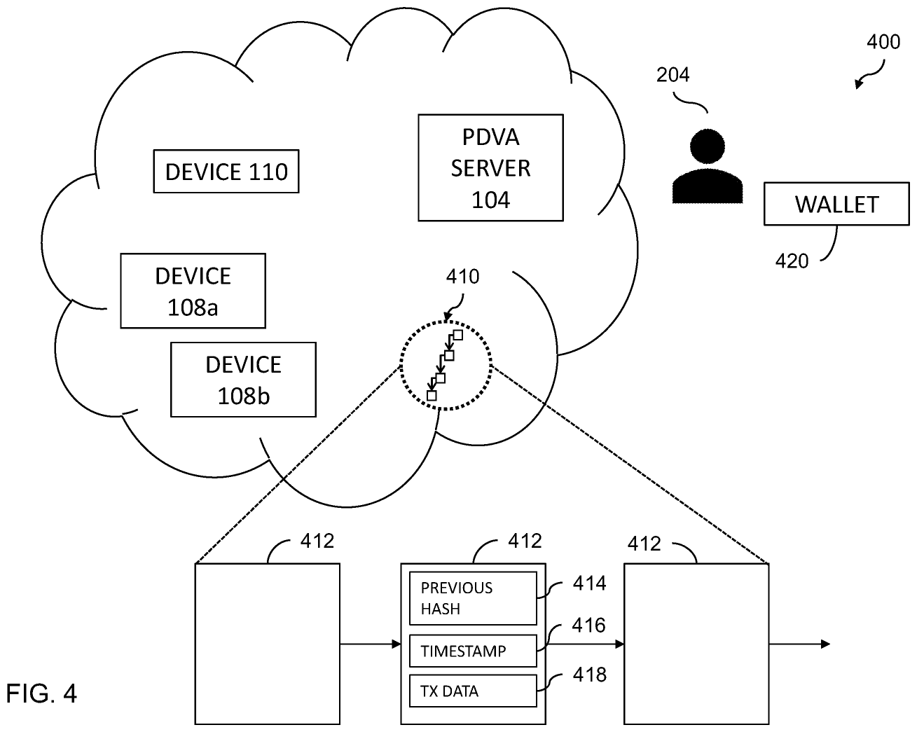

FIG. 4 depicts a networked environment of a permissionless decentralized virtual asset system 400 in which various devices provide the creation and transfer of virtual assets using a distributed ledger (e.g., blockchain) 410. In the example embodiment, the system 400 includes a blockchain network 402 (e.g., a peer-to-peer (“P2P”) network) in which various devices participate in a permissionless blockchain 410 that is used for creating, transferring, and issuing virtual assets (e.g., NFTs) and/or tokens (e.g., native tokens). In some embodiments, blockchain 410 may include multiple blockchains, each configured to perform different types of services. In some embodiments, assets or tokens may be distributed among users, ownership of which may be recorded in one of the blockchains 410. A user, such as user 204, may interface with the blockchain 410 using a wallet, such as wallet 420. In some embodiments, the user 204 may be associated with one of user devices 108a or 108b. The user's wallet 420 may be, for example, a software wallet (e.g., mobile app), a hardware wallet (e.g., a standalone, non-networked device), or a paper wallet (e.g., paper and pencil). Participating devices may include, but is not limited to PDVA server 102 and client device 110, which may be configured to create and distribute virtual assets to user devices 108 via blockchain transactions. While the participating devices may be coupled in network communication through underlying networking technology not shown or described here for purposes of brevity, it should be understood that blockchain network 402 shown in FIG. 4 represents devices participating in a P2P relationship with other devices to participate in the blockchain 410, but may also include aspects of centralized communication (e.g., between user devices 108 and PDVA system server 102). Blockchain network 402 may include any underlying networking technologies, hardware, or protocols sufficient to enable the systems and methods described herein.

In the example embodiment, the participating devices (also referred to herein as “nodes”) of the network 402 may perform transactions (e.g., asset creations, asset transfers) and track asset ownership data through the blockchain 410. In some embodiments, a user may view ownership through a web portal or blockchain viewer.

The blockchain 410 includes a linked list of blocks 412. Each block 412, in the example embodiment, includes a previous hash 414, a timestamp 416, and one or more blockchain transaction records (also referred to herein as “block transaction data,” “TX DATA”, or simply transactions or records) 418. As is known in the art, blockchain technology uses aspects of encryption and digital signatures to create a distributed, immutable ledger (e.g., the blockchain 410). The network 402 may use a cryptographic hash function (e.g., SHA-256, Merkle Trees, Keccak/SHA-3, or the like) to generate and memorialize a hash of the previous block as the previous hash 414. The block transaction data 418 may include a record for each transaction added to a particular block 412. The blocks 412 may contain other components not expressly called out here for purposes of brevity.

As is known in the art, all nodes in the network 402 execute a blockchain client that allows participation in the network 402 and maintains a copy of the blockchain 410 and may also include pending transactions received from other peer nodes prior to memorialization into a new block 412. Further, each node in the network 402 maintains a unique identity in the network 402 and may generate and use a unique public/private key pair, maintaining the private key locally and publishing the public key to other nodes in the network (e.g., for validating transactions added to the blockchain 410). It should be understood that the present disclosure uses many aspects of blockchain technology (e.g., Blockchain 1.0, Blockchain 2.0 technologies) and, particularly, for permissionless blockchains and smart contracts, that are not expressly described herein for purposes of brevity.

In some embodiments, the permissionless blockchain system 400 may be comprised of nodes in a permissionless blockchain network (e.g., network 402). In some embodiments of the blockchain network 402, nodes may, for example, interact with the network without requiring permission, create a personal address, validate transactions on the network, and send transactions to other nodes connected to the network.

In the example embodiment, certain types of blockchain transactions 418 may include various data fields that allow the blockchain 410 to memorialize various information that facilitates both the creation, tracking, and trade/selling of virtual assets 404, as well as supporting accounting, auditing, and regulatory compliance of the permission blockchain system 400.

Each such transaction may include a unique ID for the virtual asset 404. The unique ID may be a unique ID for each virtual asset created and used by the permissionless blockchain system 400. In some embodiments, the device may generate a unique ticket ID when creating the virtual asset, such as when an NFT is created. In some embodiments, the unique ID may be generated, for example, by concatenating a unique machine identifier with a unique string or index locally generated. Additionally, or alternatively, a central server may provide unique IDs to the participating nodes within the network 402 during asset creation.

During normal operation, each transaction 418 may propagate throughout the network 402 and is thus available to any of the participating devices, eventually appearing in their local copy of the blockchain 410. However, in some situations, one or more participating devices may become separated, segmented, or otherwise disconnected from some or all of the blockchain system 400.

Decentralized technology of the disclosed embodiments ensures reliability, privacy, and scalability. In some embodiments, blockchain technology is provided within an ecosystem having a decentralized architecture. In the example embodiment, the decentralized architecture provides immutability, distributed ledgers, information sharing, and transaction management without the need to rely on third parties.

For a blockchain-based digital asset system to gain meaningful traction in the broader community it is necessary to have an underlying framework for the creation and transfer of virtual assets that is performant, easy for developers to build on, and easy for users to engage with. The closed source walled gardens that currently dominate the market have a usability advantage because by controlling the whole experience they can make it seamless. They can structure the rules however they want, and a speed advantage because they can trust their own non-consensus database systems. In an exemplary embodiment, an open-source blockchain item ecosystem is provided that brings a level of interoperability and shared market and currency that prior art systems cannot achieve without extensive bilateral deals between the operators of the various worlds. By having simple tools, a unified SDK, and a lower fee structure, the barrier to entry is lower for smaller developers creating their own experiences, which are naturally interconnected with others on the network.

Prior art systems that provide open virtual item systems, such as Ethereum-based Enjin, are designed to be expensive for developers and users to interact with, charging high execution fees for each transaction. This produces very high prices to run games, which typically annoys users, requiring them to have the network's fee token before playing, and sending the bulk of the revenues to the system operators.

In some embodiments, a system is provided that makes creating and using virtual assets easy for developers and users alike. To achieve this end the focus has been put on three values: Performance, User Experience, and Cultural Integration. The system provided offers technical advantages in being fast, easy to use, and a coherent part of a user's existing life.

There are issues with existing networks, most existing NFT blockchains fail at all three of these values, possibly because they are focused on metrics that should follow and support product success, like the number of token holders or a high token market capitalization. Although these are interesting measures, by focusing on them the projects have put the cart before the horse, and created constituencies that are focused on trying to day-trade the token rather than build a system that delivers value over the long term.

In the prior art there is also an Ethereum focus, many projects put a high value on compatibility with Ethereum. Although Ethereum has the largest blockchain developer community, it is small in the context of developer communities in general. A lot of theoretical value is tied up in Ethereum tokens and a large amount of tokens change hands every day in fees on the network, but that is not necessarily a sign that Ethereum is a good choice for a system designed to support fast and large-scale computation.

In particular, the Ethereum network has very low throughput and becomes very expensive when executing complicated computations. Mathematical tricks and complicated development are necessary to use the Ethereum chain at all, and when it is used for end-user application code, it's done via “layer 2” solutions where a non-Ethereum system does all the work, and essentially records the results in the Ethereum chain. While the math behind layer 2 solutions is very interesting, and these projects are serious technical achievements, all this work and time and overhead adds nothing of value from the perspective of a user of the system or a developer building on top of it. And Ethereum developers need to learn a new programming language, Solidity, to do any work at all. A lot of time has gone into creating a way for systems to record their state in the Ethereum chain, but very little has gone into the things that matter most.

There is also a lack of usability focus, no existing blockchain system has simple SDKs, none offers smoothly designed mobile wallets, and no systems integrate smoothly with in-app purchasing, the main way that users buy digital assets today. These are the problems that stand between the digital asset world and mass adoption. Users will not make decisions about what experiences to consumer based on the top line market cap of a token.

The disclosed embodiments solve these three problems by focusing on the user and developer experiences first, and the internal crypto enthusiast marketing second. This disclosure advocates implementing a simple SDK for item creators to use, built on top of a fast blockchain that isn't tied down to Ethereum, and built a clean mobile application that integrates simply and easily with in-app purchasing (e.g., Google Play®). Having a system that has usage by regular users provides a better long-term strategy than building a large amount of theoretical value in a token before delivering on a real product.

Performance is the bedrock of a computing system. A system that cannot support many transactions will simply not be used for many transactions. Core to achieving performance in the exemplary embodiment, a software development kit (SDK) may be used, such as Cosmos SDK, as the underlying technological platform. The SDK may include a set of tools for building self-contained, fast blockchains. Additionally, the self-contained blockchains may operate on top of a proven and fast consensus engine. The consensus engine may be designed to operate in an operating system, such as a mobile operating system (e.g., Android Go®), on top of a backend database (e.g., LevelDB®). The configuration of the exemplary embodiment may include fast technologies and support very fast transaction resolution.

In some embodiments, a developer may define what a backend database may contain, and the transitions permitted within it. Data stored on the backend database may include, but is not limited to, different kinds of data that blockchains often hold, such as accounts and asset balances, for example. The SDK used by developers enables the developers to focus on how the data set can change and provides the building blocks needed to launch the data set as a blockchain. In some embodiments, the SDK may include a plurality of modules. The modules may include, but are not limited to staking, transfer, and governance. The exemplary system provides users with the capability to communicate and hold each other's assets, so items can be transferred between users within different areas, or zones, to the extent that users trust the zones in question.

In one exemplary embodiment, the system may provide an interface for developers to create virtual assets. Additionally, the interface permits developers to create virtual assets even if they have little to no computer programming knowledge. Further, in the exemplary embodiment, the developer may create virtual assets applicable to essentially any use case that might be desired in the real world. For the most part, the kinds of use cases that require Turing-completeness are not broadly necessary in NFT systems. Actual use cases that will scale to millions of users will have simple rules, issue some number of items to some set of users, and allow some actions to be performed with those items that generate other items. A system with loops is not required to sell virtual art.

Without loops, the experiences created by the provided system are fast to execute, and much less expensive to operate than they would be on a blockchain that uses a full virtual machine. The exemplary system may provide games free to users, which solves a big piece of the user acquisition problem of NFT systems.

From a usability perspective, the largest piece of the user acquisition puzzle is the hostility of blockchain software to people who are not interested in blockchain per se. It is baroque, hard to install, scary to use, full of terms users don't know, and full of what feel like pointless hoops to jump through. The disclosed embodiments provide a system that is easy to get started with. For example, one or more apps of the disclosed may be downloaded from a mobile app store (e.g., Google Play) and work without complex configuration. In some embodiments, the one or more apps may be a game. During a gameplay, all user actions may be recorded on a blockchain. The process of storing user actions on the blockchain is not visible and therefore not evident to the user playing the game.

The network may support the use of a plurality of cryptocurrencies (e.g., ERC-20 tokens, native tokens) and other digital assets (e.g., NFTs). A native currency, or token, may be used, for example, among a plurality of applications (e.g., mobile apps, mobile games, or the like) within the networked environment. Additionally, users may obtain native tokens, such as via in-app purchases or from other networked users, and store tokens in their cryptocurrency wallet. Users may then use the acquired tokens among applications within the networked environment.

For example, tokens may be used for in-game purchases.

Systems and methods may be provided for minting cryptocurrency. The blockchain may be capable of natively handling a signed receipt for an in-app purchase from an entity (e.g., Google) and creating and issuing the purchased tokens to the correct user automatically. There is no third-party server involved, and users do not need to go to an exchange to buy native tokens. Users can simply buy native tokens whenever they want from the network using a mobile app store (e.g., Google Play) with real money, such as U.S. dollars from inside Pylons apps. Users are accustomed to buying in-game currency this way.

In the exemplary embodiment, the networked environment may provide the ability to use the native token in other contexts which will increase a user's confidence that native tokens may be purchased in the context of one experience that will always be valuable for other experiences as well.

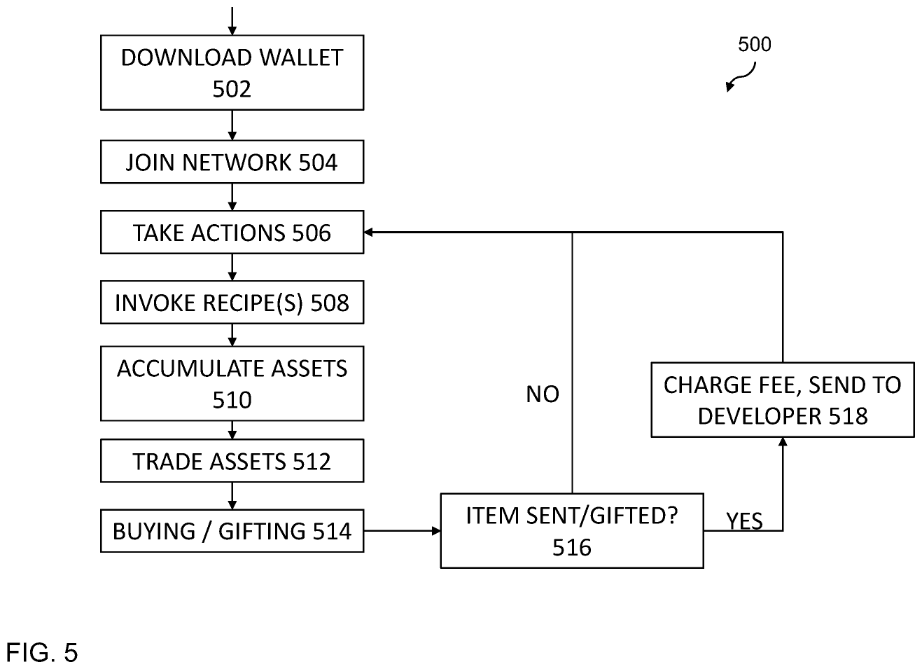

FIG. 5 is a data flow diagram 500 illustrating various blockchain operations performed within the permissionless system 400 by a user, such as user 204. In the example embodiment, diagram 500 illustrates a user's interaction with system 400. A user, such as user 204, may join the network by downloading 502 a wallet (e.g., wallet 420 of FIG. 4) from a mobile application store, such as the Google Play store. The wallet may be integrated into another application that may be downloaded or may be a standalone application. In some embodiments, when the wallet is integrated into another app within the system, the user may begin using the app immediately. If it's a standalone wallet, the user may download an application within the system, connect it to the wallet, and start using it that way. Either option may be utilized by a user when joining 504 the system.

Most users may interact with the system by taking 506 one or more actions, such as taking free actions in the system. Actions a user may take are implemented by invoking 508 “recipes” that are on the network which describe how the user may transform different NFTs and app-specific currencies into other NFTs and currencies. The experience generated by a collection of such recipes may be, for example, a game, a purchase of art, or any number of other experiences a developer may implement.

By taking actions in the apps, users may accumulate 510 different types of virtual assets including, but not limited to, valuable NFTs and app-specific coins generated from experiences in the app or purchased in the app. For example, a user may acquire tokens by buying from a mint, such as via an in-app purchase or IBC transfer. In step 512, the user may trade accumulated assets. Trading 512 may include selling virtual assets to other users within the network via a market. Additionally, or alternatively, the user may be a free user and therefore only be able to sell virtual assets, such as an NFT they created, on the market. Once a user has acquired tokens for use within the network, the user may access certain parts of the system, such as a paid user area, for the buying and gifting 514 of digital items. Each item may have a minimum transfer cost set by the developer of the recipe that created it. Alternatively, the minimum transfer cost may be set based on a network minimum. When a user sells an item in the market or sends the item as a gift to another user, the minimum transfer fee may charged 516 and sent to the developer.

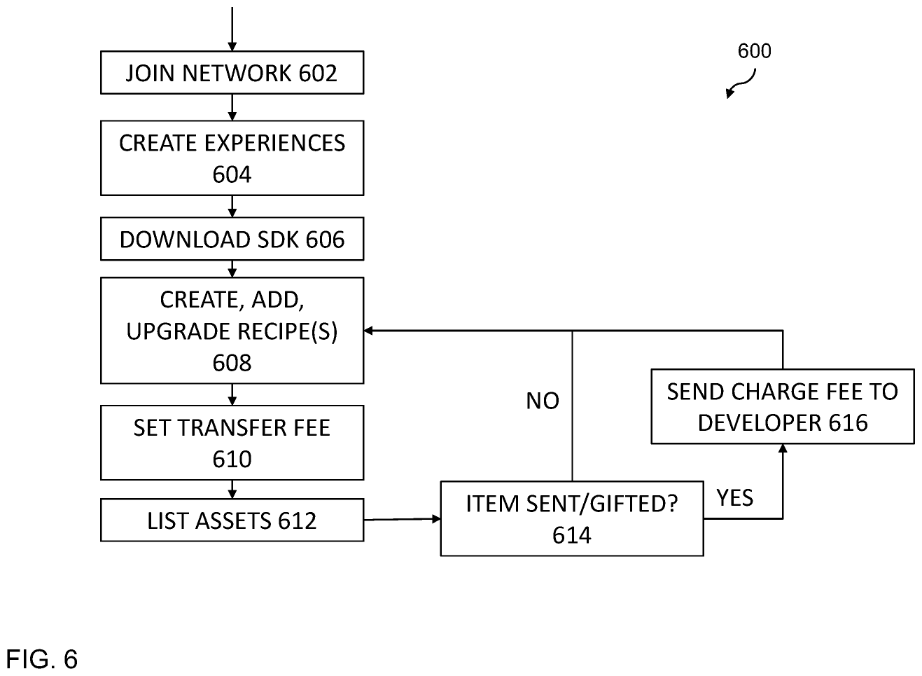

FIG. 6 is a data flow diagram 600 illustrating various blockchain operations performed within the permissionless system 400 by a developer. A developer may be associated with a computing device, such as computing device 110 (shown in FIG. 1) and join 602 a network, such as network 410 (shown in FIG. 4). Developers may create 604 experiences on a system, such as system 400, by putting “recipes” for creating NFTs together in “cookbooks” that define a world. In one example, for a game, this is a set of rules, for an artist, they are the rules for transferring and displaying the digital art, etc. Developers may create experiences by downloading 606 a software development kit (SDK). The SDK may provide a client for creating cookbooks, adding recipes to them, and upgrading the recipes when they need to be changed.

In some embodiments, recipes create items, which can optionally be built off of item templates that are also JSON files. Developers may set 610 a minimum transfer fee for each item and a percentage of the sale price for any item sold on the market. In step 612, developers may make assets available for sale, transfer, or trade within the network system. In some embodiments, data pertaining to the assets may tracked and stored on a blockchain. When an item is traded, sold, gifted, or sent in step 614, a charge fee may be sent, in step 616, to a developer. In one example, the payment of a charge fee may be triggered by a smart contract created at time of asset creation by the developer. Developers may create compelling experiences that generate items people value highly and will receive the vast majority of the revenue generated by the system. A game designer could set high transfer prices on rare or powerful items and continue to earn revenue every time such an item changed hands, even if the original player who generated it was no longer playing the game. An artist could issue a limited number of rights to use an image as a video chat background, video clients could check that the person attempting to use it had a valid license, and the artist would automatically be paid every time the license changed hands. The possibilities for the creation of virtual items that users are attached to and feel express who they are is powerful may be lucrative. The list of ways that programmable assets may be used in the world is not considered exhaustive.

The rules that developers define to transform NFTs into other NFTs are called “recipes” and the collections of recipes that interact to create a complete experience are called “cookbooks.” Every asset is associated with the cookbook that contains the recipe that created it, and a recipe can only interact with items associated with its cookbook. Developers create experiences by creating and publishing cookbooks, and then use the SDKs to build the client apps that allow their users to execute the recipes in those cookbooks.

In one example cookbook, the cookbook may contain several kinds of recipes. Each action the user takes is represented by a recipe that contains its possible outcomes. For example, there may be a recipe for creating a new character in the game, a recipe for buying a sword for that character, which always have the same outcomes. Then there are recipes that have outcomes determined from a set of possibilities. Fighting a goblin can result in a victory, returning the character, as well as some gold, and occasionally some goblin ears, but can also result in defeat, in which case the recipe does not return the sword, and sometimes does not return the character. By using simple mathematical operations to drive the probabilities of the outcomes, developers can make games with interesting choices, and non-game experiences with exciting non-random outcomes. As a player advances through the example game, they may acquire rarer items that take more investment of time to get. Risking them to progress further becomes an emotionally engaging experience.

Alternatively, recipes may power more than games. They can support the licensing of digital art, the creation of collaborative work, or the mementos of physical experiences. In some embodiments, an app with a QR code could both allow you entrance to an event and serve as an address to send a digital hand stamp that could be traded, validated by the system, and used to enable some other right.

For hybrid models and existing worlds, the system is also useful to developers who have existing worlds or who have systems that are too complex or fast-paced to put entirely on the blockchain. Coswar demonstrates the ability for a server to act as an oracle for resolving transactions that do not occur on chain. The two simplest ways this can work are hybrid models and integrating into existing experiences.

An example is a Hybrid Model-Collectible Card Game, One possible use of the system is for the pack opening and trading system for a collectible card game like Magic: The Gathering® or Hearthstone®. Even with card interactions that are complex to model, it is possible to manage collections of cards, card trading, and choice of deck for a game in the network, and use a remote oracle to track outcomes. This will have the advantage of creating a broader community potentially interested in the game's assets, and a revenue stream for asset resale that the developer does not need to manage directly.

Another example is an existing virtual world, with FPS skins, many blockchains have tried to manage FPS skin trading, WAX being one notable attempt that raised a lot of money. But since skins in most FPS games are not native to the chain, there is not really any value provided by using a blockchain to trade them. The exemplary network allows games to use a reliable open network as the source of truth for items like skins, with support for the kinds of loot box and contest mechanics that are commonly used to determine how they are distributed. Again this provides a secondary market and ongoing revenue stream for the skins, plus a way for players to cryptographically prove that they own the skin, and potentially display it in a different context like a message board, social profile, or video chat.

In terms of native tokens, the system may be tied together by a native token. The native token may be easily purchasable through an app store, such as the Google Play Store. The tokens may power the revenue models for the network and the creators that use it. They also provide a central asset for the user community that allows people with different kinds of assets to interact, and provides developers with an existing base of users who have valuable currency they are ready to spend in virtual experiences. There are three main ways that the native tokens may be spent and become revenue for experience creators.

In one example, premium recipes are allowed to specify native tokens as an input (though not, of course, as an output). When a user invokes a recipe that has a token input, the network takes a percentage as a fee, and sends the rest to the account that owns the cookbook. The premium recipe flow is well known in the mobile game world, where a real money equivalent currency is spent to increase a player's stamina points, prevent a loss of an item, gain an advantage in a battle, and other things of that nature. Players are often willing to spend real money to circumvent a grind for resources, and some are willing to spend a lot of money.

For an item market, users can place items on an orderbook for a price of their choosing in the native token. If someone buys the item, a flat fee goes to the network, and an additional percentage of the price (set by the cookbook owner) goes to the cookbook owner, with the network taking a percentage of that fee as well. Users can also place buy orders, where they specify the kind of item they are looking to buy, and what they are willing to pay for it, and a user with a matching item can fill the order. In a vibrant experience with a strong community, the same asset, created only once, can generate revenue for the experience creator over and over every time it is sold.

Cookbook owners can also set a fee for transferring an item between wallets. This is partly to lessen the incentive to create ‘feeder’ accounts that automate free actions and transfer the resulting item to the main account, and partly to ensure that if a valuable trade is negotiated off chain, that the developer is still able to take a transfer fee from that transaction. The network may take its percentage of that fee too.

To cash out, the network would buy native tokens generated by bona fide usage in experiences from the experience creators at a reasonable price (i.e. close to the lowest price they are minted for) subject to regulatory restrictions. Tokens can be sent between users at will, and since the network supports Inter-Blockchain Communication, can be sent out of the network entirely to be used at will.

A mobile application store (“Store”), such as Google Play, typically has a technical flow that can be integrated into a blockchain as follows: Each purchase has an item ID, and when making the purchase the client can optionally provide an identified string. The identifier string identifies at least the wallet the tokens should be minted into, and the item ID specifies the quantity. When the wallet receives authorization from the Store, the response includes the item id and the identifier, all signed by a business entity (e.g., Google). These values are passed to the network, which confirms that they are signed with the business entity's key (which is present in the node configuration and treated as an oracular key for this purpose). If the signature is valid, the tokens are minted to the wallet in question. The client then confirms that the tokens were minted and informs the business entity that the transaction is complete.

An SDK, such as the Go SDK, is designed to support the creation and publishing of recipe sets, and to support the creation of Go clients for specific cookbooks, which essentially means game clients. It is built off of gaiacli, the Cosmos command line client, and contains the commands a developer needs to create, test, and update an experience. Developers may write JSON recipes and submit them to the network with the SDK.

In some embodiments, the wallet manages the user's keys, gives the user a view of all their assets and market orders, allows the user to set budget for particular apps, and manages requests for actions from those apps using inter-process communication on the user's phone.

In this way the wallet is transparent to the user at most times during use of an app. If the app wants to exceed a budget or purchase more tokens, the user will receive a notification and will be able to approve or deny the request from the notification, without ever needing to leave the app they are using. This is accomplished by using a custom messaging system on top of Android intents.

Apps may be built using an SDK provided both for native Android and for Unity that will make integrating with the wallet seamless.

The Android SDK will be an easy way to build Android apps on the network. It will communicate with the wallet, which then communicates with the network. It may provide simple functions to call to execute recipes that return promises, so developers will not need to be involved with how the network operates or any of the network protocols. Much like the Android SDK, the Unity SDK will allow developers to easily call the recipes that power a game, but it will be structured as a Unity plugin, so developers will not need to be involved in any Android native coding in order to build a network experience.

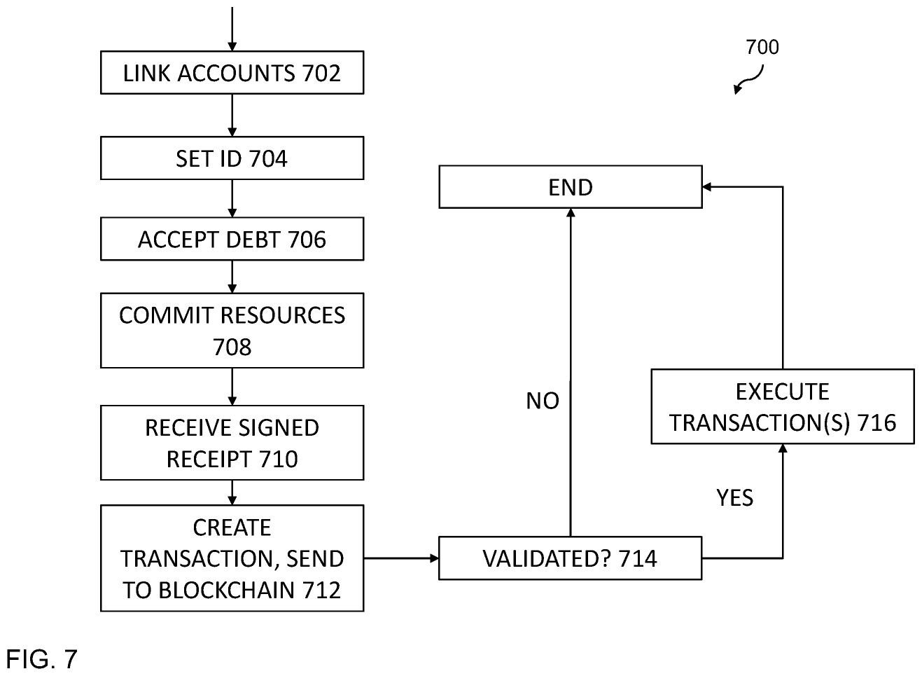

FIG. 7 illustrates an exemplary method 700 for providing a decentralized exchange including a user-driven interface with an external authoritarian system. Method 700 may be performed by PDVA computing device 102 (shown in FIG. 1). Data pertaining to the decentralized exchange, such as user data, asset data, or the like, may be stored within a storage device associated with PDVA computing device 102, such as database 106. In some embodiments, the stored data may be stored on a blockchain and distributed among a plurality of devices, such as on a peer-to-peer network or other type of distributed network. Further, an external authoritarian system may be provided, such as

Method 700 may include linking 702 one or more of their consensual accounts to one or more of their authoritarian accounts. A user may initiate a transaction, such as a blockchain transaction, that associates one of their consensual accounts with one of their authoritarian accounts.

Method 700 may further include setting 704 an account identifier (ID) on a user's profile. An account ID may be, for example, a Stripe® account ID. An account ID, for example, uniquely identifies the user on a payment network and may be generated automatically for the user upon account generation.

Method 700 may further include the user signaling 706 that they are willing to accept debt on a particular authoritarian platform they have linked. An authoritarian platform may include, but is not limited to, a payment processor, a publisher, or a mobile app store (e.g., Google Play®, Amazon® AppStore, etc.). In another example, the external authority may be a game publisher running a server for lower-latency behaviors, such as individual battles in a trading card game. That game publisher may be an authority on who won a particular game, and could sign receipts for a victory. Additionally, two players may sign a contract which ends one of two ways, the result to be determined by an outside signature. Continuing with an above example, the user, in this example the user being a developer, may formulate a recipe that is provided on a network, such as a blockchain network of FIG. 4. When the developer sets a price for the recipe (e.g. US Dollars), a SKU may be created, such as a Stripe® SKU, and is associated with the recipe.

Method 700 may further include the user committing 708 resources on the authoritarian system towards the execution of a transaction that involves external debt. In this case a credit card payment towards the SKU. This step may permit other users connected to the platform to purchase the recipe, for example.

Method 700 may further include the user receiving 710 a signed and uniquely identified receipt from the authority. For example, after another user purchases the item identified by SKU. The receipt may be digitally signed using encryption methods that uniquely identify the external authority, for example.

Method 700 may further include, without the reliance on an oracle, the user constructing 712 a message with that receipt, and submits it to the consensual system. Method 700 may further include the system validating 714 that the receipt is correctly signed and has not been redeemed. Validation may be performed through confirmation on a blockchain by a plurality of users acting as validators on the blockchain network. For example, once a consensus on the blockchain network is reached, based on settings of the blockchain, the transaction will be considered confirmed (i.e. valid). Method 700 may further include the system executing 716 the appropriate transaction to the benefit of the user. For example, the purchasing user may receive the purchased item (e.g., the recipe) and appropriate payment will be made to the seller via the blockchain.

In some embodiments, an online marketplace may function by helping users create trade offers that give the marketplace a cut when they are accepted. The marketplace may list and promote those trade offers on its platform and to its users. In this example, no permission is needed to operate a marketplace on top of the platform. Further, when users are convinced to make offers with a cut for another, the users can do it, and a marketplace is established, without the need to rely on a network operator.

In some embodiments, a blockchain may be created to connect people and experiences using digital property. Typically, experience designers want to control the experience as completely as possible, and because most people want to pay in fiat currency, such as US dollars, the blockchain may be designed with tokens meant to engage users, get those users to pay money, and then distribute that money to owners. To that end, the blockchain may provide a platform comprised of engagement tokens, payment tokens, and ownership tokens.

Of these, engagement tokens and payment tokens may operate on a contained proof-of-authority model. Bringing the reliance on authority into the chain where it can be tracked and limited is preferable to keeping the chain completely free of authority, but then requiring a centralized external authority like an exchange to handle interactions. Payments on the chain may be handled for tokens that are valuable because the payment processor will honor its contracts, and that engagement tokens can be issued by publishers at will, but items on the chain are controlled by the users and cannot be altered or revoked by the item creator.

The exemplary platform may include ownership tokens. Ownership tokens may provide for governance and revenue distribution for the blockchain. Further, ownership tokens may be redeemed for experiences or items on the platform.

The exemplary platform may include engagement tokens. Engagement tokens may, in some embodiments, be of infinite-supply and controlled, such as by a publisher. In some embodiments, engagement tokens may be used to incentivize users to connect with the platform and be a participant. Engagement tokens are not meant to be perceived as money or having any monetary value.

In one example, the platform, at launch, may include at least one blockchain and at least one engagement token. In some embodiments, the engagement token may be used, redeemed, platform wide. The engagement token may be purchased within the platform, such as from a token seller, marketplace, or the like, that is authorized by the platform. Token sales, ownership, and transfer may be tracked using the at least one blockchain or by another distributed ledger. The platform may include one or more applications, each of which may be managed by users of the network. Users that manage applications may be referred to as operators. Additionally, an authorized token seller may buy back tokens from application operators. The engagement token may be distributed to users for performing certain actions on the platform including, but limited to, minting, buying, and trading NFTs, referring other users, or the like. In some embodiments, governance may be used to onboard other publishers to create their own engagement tokens.

Payment tokens may be an infinite-supply of tokens controlled by a payment processor. In some embodiments, payment tokens may be issued on the exemplary platform to a seller or experience when a fiat purchase is made (less network fees) and tracked on a blockchain. The receiver must have an account with the payment processor, and the tokens are not transferable. Payment tokens may be redeemed for payment in fiat on the processor's platform.

Another type of token on the exemplary platform may be a cookbook token. A cookbook token may be part of a cookbook described herein and above. A cookbook may have any number of cookbook-local tokens, that operate entirely within the cookbook according to its rules. They may not be accessed from other cookbooks.

Yet another type of token that may be provided on the exemplary platform is an ownership token. In some embodiments, an ownership token may be primarily a revenue sharing token for users considered to be investors in a blockchain launched by the platform. Holders of ownership tokens may receive a percentage of transactions in the form of engagement tokens, payment tokens, or both. The percentage may be set by governance. Holders that stake an amount of ownership tokens may be categorized as validators. Validators may be nodes on the blockchain network that validate the blockchain. Additionally, ownership tokens may be transferable between platform users. The ownership may be provided at launch via a single transaction post-genesis.

The exemplary platform may provide redelegation of token assets. For example, a holder of an ownership token may change the validator the token is delegated to. Additionally, or alternatively, the platform may be enabled to provide token holders to transfer or trade of ownership tokens while delegated. Further, after the transfer, ownership tokens will stay delegated and cannot be undelegated.

In some embodiments of the exemplary platform, token assets on the blockchain may be minted. For example, engagement tokens may be minted through a mobile store (e.g., Google Play®), an online marketplace, or payment processing software (e.g., Stripe®). Engagement tokens may be issued to users for engaging in activities on the platform.

In one example, a user may purchase, or mint, an engagement token to be used on a platform by way of a mobile app store (e.g., Google Play®). The user may purchase a SKU, where the SKU may be associated with a set quantity of engagement tokens. After purchase, the user may receive a signed receipt which may then be submitted by the user to a blockchain of the engagement token in the form of a transaction. Based on the signed receipt submitted by the user, the blockchain may issue the tokens to the user. Additionally, the blockchain may ensure that each signed receipt is redeemed only once. The blockchain, for example, may be configured to accept the signed receipt as a source of truth and does not require another query being made to the mobile app store.

To mint Pylons on Google Play, a user buys the SKU associated with a quantity of Pylons in the store. The signed receipt is submitted by the user to the chain to authorize the issuance of the tokens. The chain ensures that each receipt is redeemed only once, but does not query Google Play, it accepts the signature as a source of truth. Tokens may be issued to platform users via an issuance transaction.

Further, the exemplary platform may provide a blockchain, which may be set of blockchains, that operates one or more recipes, as described herein and above. A developer, or creator, may use a recipe to specify state transitions of an experience. The platform may create a reward recipe that connects to an existing recipe which users may execute to claim tokens (e.g., engagement tokens). For example, the user may claim tokens by submitting the execution identifier of the original recipe. Any recipe on the chain may call for an ecosystem token as an input. The network takes fees on ecosystem tokens just like on payment tokens. Ecosystem token operators are responsible for ensuring that any buyback plan they run is legal. Ecosystem tokens are intended to be transferable.

On the exemplary platform, a developer, or creator, may desire to charge fiat (e.g., USD) for a transaction. To charge fiat, the developer may create an account with a payment processor, such as a Stripe® merchant account. The developer may join the platform using an API of the payment processor (e.g., Stripe Connect), and link their payment processor account (e.g., Stripe Connect ID) to their platform account. Developers may then generate SKUs on the payment processor (e.g., Stripe®). When a platform user buys the SKU, the user may submit the signed receipt from the payment processor (e.g., Stripe) to the platform's blockchain as part of an execute recipe transaction. If successful, the recipe owner may receive the payment processor's fiat (e.g., Stripe USD) (less network fees, which send some of the payment processors fiat to ownership holders and validators).

In some embodiments, the example platform may provide burning of digital assets. For example, a payment processor fiat (e.g., Stripe USD) may be burned in connection with payment of USD to a merchant via payment processor (e.g., Stripe) using the payment processor's API (e.g., Stripe Connect). This may be done by submitting a signed receipt of a payout to the merchant, for example.

The exemplary system provides blockchain network participants with linked consensual and authoritarian accounts with the ability to pay for various items (e.g., products, goods, services, etc.) using a fiat currency (e.g., USD). The participants may then have fiat currency-denominated debt on the blockchain network. Further, the debt need not be tradeable on the blockchain network, but instead need only be used for redemption transactions when a participant on the blockchain network (e.g., a merchant, a validator, a staking token holder) cashes out of the system.

On the exemplary platform, a blockchain may be configured to support multiple tokens (e.g., engagement, reward, etc.) where each token serves a different purpose on the network. In some embodiments, the blockchain may shard, causing some tokens to be native to some shards, but not to others. For example, if a game company is running one shard, that company's engagement token may be native to its own shard, but it would still be able to be moved to other shards, such as via an IBC. Further, engagement tokens may be tokens that exist to reward users in ways that are not tradeable for money. In this example, the payment tokens exist to encapsulate the risk and debt (or other counterparties) and the ownership tokens may exist to distribute the fees the network may collect. Additionally, or alternatively, ownership tokens may be denominated in engagement and payment tokens.

In some embodiments, a consensual system may be provided. The consensual system may be implemented by a computing server, such as computing server 102 of FIG. 1. The consensual system may comprise of one or more blockchain networks. The consensual system may, for example, include a strict subset of transactions that require approval from an external authority to be considered valid. The external authority may be in the form of a signed message that authorizes a limited number of transactions. The external authority may be, for example, one of many external authorities. An external authority may be an exchange, such as a cryptocurrency exchange, or the like. Additionally, the external authority, or authorities, may be established during network launch (i.e., when a blockchain goes “live”). The external authority may be changed after launch. Voting within the network may be performed using tokens, such as native tokens of a blockchain. In some embodiments, network users may vote by staking some or all their native tokens. Staking transactions on the network may be limited, such as on a per-user basis. Limits may be set by the user or one of the authorities, such as by signing a message authorizing a network user. In some embodiments, approval may be submitted by a client, or a user, that had requested a transaction. In another aspect of the exemplary embodiment, a set of beneficiary accounts may be specified.

### Additional Considerations

The computer-implemented methods discussed herein may include additional, less, or alternate actions, including those discussed elsewhere herein. The methods may be implemented via one or more local or remote processors, transceivers, servers, and/or sensors (such as processors, transceivers, servers, or associated with smart infrastructure or remote servers), and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

As will be appreciated based on the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only and are thus not intended to limit in any way the definition and/or meaning of the term “processor.”

As used herein, the terms “software” and “firmware” are interchangeable and include any computer program stored in memory for execution by a processor, including RAM memory, ROM memory, EPROM memory, EEPROM memory, and non-volatile RAM (NVRAM) memory. The above memory types are example only and are thus not limiting as to the types of memory usable for storage of a computer program.

In one embodiment, a computer program is provided, and the program is embodied on a computer readable medium. In an example embodiment, the system is executed on a single computer system, without requiring a connection to a sever computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein.

Each component and process can also be used in combination with other assembly packages and processes.

As used herein, an element or step recited in the singular and preceded by the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

The patent claims at the end of this document are not intended to be construed under 35 U.S.C. § 112(±) unless traditional means-plus-function language is expressly recited, such as “means for” or “step for” language being expressly recited in the claim(s).

This written description uses examples to disclose the disclosure, including the best mode, and to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. At least one non-transitory computer-readable storage media having computer-executable instructions embodied thereon for containing authority within a distributed consensual system, the distributed consensual system including a blockchain network, wherein, when executed by at least one processor, the computer-executable instructions cause the processor to:
create an account linking blockchain transaction to link a developer account with an external authority account;
broadcast the account linking blockchain transaction on the blockchain network;
publish a recipe associated with the developer account;
receive, from an external authority, a receipt indicating purchase of the recipe by a computing device connected to the distributed consensual system;
create a recipe blockchain transaction including data identifying the recipe and the receipt
broadcast the recipe blockchain transaction on the blockchain network; and
receive payment from the computing device via the blockchain network in response to validation of the recipe blockchain transaction by the blockchain network.

2. The at least one non-transitory computer-readable storage media of claim 1, wherein a SKU is assigned to the recipe by the external authority.

3. The at least one non-transitory computer-readable storage media of claim 1, wherein the received payment is made in a native token of the blockchain network.

4. The at least one non-transitory computer-readable storage media of claim 1, wherein the receipt is signed and uniquely identified by the external authority network.
